(19) United States
(12) Patent Application Publication
(10) Pub. No.: US 2018/0220604 A1
(43) Pub. Date: Aug. 9, 2018

(54) IN-GROUND ROOT PROTECTION SYSTEM AND METHOD

(71) Applicant: Shai ZEMACH, Kfar Yona (IL)

(72) Inventor: Shai ZEMACH, Kfar Yona (IL)

(21) Appl. No.: 15/769,069

(22) PCT Filed: Oct. 25, 2016
(86) PCT No.: PCT/IL2016/051145

§ 371 Date: Apr. 18, 2018

Related U.S. Application Data
(60) Provisional application No. 62/244,749, filed on Oct. 22, 2015.

(51) Int. Cl. A01G 31/02; A01G 13/02; A01G 9/029; A01C 23/04; A01C 21/00; A01G 29/00; A01G 25/00; A01G 27/00; A01N 25/34

(52) U.S. Cl. CPC A01G 31/02; A01G 13/0237; A01G 9/0291; A01C 23/042; A01N 25/34; A01G 29/00; A01G 25/00; A01G 27/003; A01C 21/00

(57) ABSTRACT

A method and system for protecting roots of plants, including: an encasement disposed in a hole formed in soil, the encasement serves as a barrier between contents of the encasement and the soil surrounding the hole; and a feeding means, for communicating sustenance to roots of at least one plant disposed in the encasement.

### FIELD OF THE INVENTION

The present invention relates to a system and method for protecting roots of plants grown in the ground. The system and method disclosed herein is primarily directed towards produce planted in the ground as seedlings. While the disclosure relates to the aforementioned items, it is made clear that the method and system can be applied to other aspects of agriculture, wherever roots of plant life are usually brought into contact with earth, and thereby inherently susceptible to the various dangers of ground-based agriculture including, but not limited to, both pests and pesticides.

### BACKGROUND OF THE INVENTION

Many plant growing systems exist today, each with its advantages and disadvantages.

Hydroculture is a form of passive hydroponics and a way of growing plants without soil. Passive hydroponics systems often use an inert growing medium such as clay pebbles instead of soil. The different methods of hydroculture farming allow for growing plants in a controlled environment, generally speaking these methods are effective in terms of water consumption and plant yield, but require high initial infrastructure costs (e.g. building hothouses, acquiring advanced irrigation systems etc.) as well as high, ongoing, maintenance costs.

Field farming generally requires low maintenance and less expensive equipment and infrastructure. But is wasteful in terms of water and fertilizer consumption and exposes the plants to different pests and diseases in the environment. Growers use harmful pesticides to neutralize these dangers.

The term ‘pesticide’, as used generally, and as referred to herein, includes all of the following: herbicide, insecticide, insect growth regulator, nematicide, termiticide, molluscicide, piscicide, avicide, rodenticide, predacide, bactericide, insect repellent, animal repellent, antimicrobial, fungicide, disinfectant (antimicrobial), and sanitizer.

In a similar manner, the term ‘pest.’ is used herein to generally refer to all the living organisms that are harmful to the plants, including but not limited to: insects, mites, snails, nematodes, etc., bacteria, fungi, etc.

Rising use of pesticides in soil farming damages the environment. Seepage of pesticides into ground water poisons the water. The poisoning of living organisms damages the ecological system.

Solutions against airborne or above ground pests exist in the form of nettings, nylon or glass greenhouses, etc. On the other hand, finding a solution for underground pests (insects, mites, snails, nematodes, etc.), bacteria, fungi, etc., which attack the plant's roots, is much more complex. Gas methyl bromide was widely used to fumigate the ground before planting, but methyl bromide was found to be damaging to the ozone layer and has been banned from use in most countries. No effective solution has been found to protect the plant's roots.

Land degradation in vast parts of the world mostly due to human firming activities and climate changes leave many strips of land unfertile, therefore it would be advantageous to develop a system which allows farming even on unfertile land or farming on fertile lands without damaging them.

### SUMMARY OF THE INVENTION

There is provided a novel root protection system and method that allows for growing plants in the field (in-ground) using existing foundations and equipment, while keeping the roots of the plant in a protected and controlled environment.

According to the present invention there is provided a system for protecting roots of plants, including: an encasement disposed in a hole formed in soil, the encasement serves as a barrier between contents of the encasement and the soil surrounding the hole; and a feeding means, for communicating sustenance to roots of at least one plant disposed in the encasement.

According to further features in preferred embodiments of the invention described below at least one plant is secured in a mouth of the encasement, such that roots of the at least one plant descend into the encasement and a stem and flower of the at least one plant protrude above the soil.

According to still further features in the described preferred embodiments the encasement is a formed of a flexible material and at least one plant is secured in the mouth of the encasement by the soil packed against the stem, trapping an upper edge of the flexible material against the stem.

According to further features at least one plant is secured in the mouth of the encasement by a support arrangement resting atop the soil in which the hole is formed.

According to further features at least part of the encasement has at least one characteristic selected from the group including: biodegradable, semi permeable, non permeable, flexible, semi-rigid, rigid, insulated, chemically treated on an internal surface, an external surface with one or more substances selected from the group including: pesticides, herbicides, weed control agents, pest control agents, ascaracides, molluskicides, insecticides, fungicides, nematocides.

According to further features the system further includes a rigid structure disposed inside the encasement, the rigid structure adapted to support the encasement, which defined an internal volume therein, against external pressure.

According to further features the feeding means includes an irrigation conduit operationally coupled to a sustenance reservoir on a proximal end and disposed inside the encasement on a distal end, the irrigation conduit adapted to communicate sustenance from the sustenance reservoir to the roots.

According to further features the sustenance reservoir includes at least one of fluid, gas and nutrients. According to further features a pump adapted to move sustenance through the irrigation conduit under pressure. The pump is adapted to selectively propel the sustenance from the sustenance reservoir to the encasement and suction material out of the encasement. The pump is adapted to communicate gaseous material from a gaseous reservoir to the encasement. The gaseous material is heated or cooled.

According to further features an internal volume of the encasement is partially filled with sustenance such that only a portion of the roots are in contact with the sustenance. According to further features the system further includes an irrigation conduit adapted to sustain a predefined level of the sustenance.

According to further features the system further includes a floater device adapted to allow sustenance through the irrigation conduit into the internal volume when the sustenance in the internal volume is below the predefined level and to disallow sustenance through the irrigation conduit when the sustenance is above the predefined level.

According to further features the system further includes a pump operationally coupled to the irrigation conduit and configured to override the floater device. According to further features the irrigation conduit has a spray nozzle disposed at a distal end thereof.

According to further features the feeding means includes: a sustenance reservoir disposed in the encasement, and a non-porous material operationally coupling the roots to the sustenance reservoir such that the roots receive sustenance from the sustenance reservoir by capillary action.

According to further features the system further includes an irrigation conduit operationally coupled to an external reservoir on a proximal end and disposed inside the encasement at a distal end, the irrigation conduit adapted to communicate sustenance from the external reservoir to the sustenance reservoir disposed in the encasement.

According to further features the encasement includes a plurality of plants and wherein the plurality of plants is secured in a mouth of the encasement by a support arrangement.

According to another embodiment there is provided a method of providing in ground root protection, including: providing a hole in the ground; inserting an encasement in the hole; inserting a plant in the encasement such that roots of the plant are disposed inside the encasement and at least part of a stem of the plant protrudes out of the encasement; providing sustenance to the roots disposed in the encasement.

According to further features the sustenance is housed in an external reservoir and conveyed to the roots via an irrigation conduit. According to further features the sustenance is disposed inside the encasement. According to further features the encasement further comprises non-porous filling and the sustenance is conveyed to the roots via capillary action.

According to further features the sustenance is conveyed in a vapor form. According to further features material disposed in the encasement is extracted via the irrigation conduit. According to further features the plant is held in the encasement by a support arrangement. According to further features the support arrangement secures a flexible edge of the encasement against the stem.

According to another embodiment there is provided a method of providing in ground protection, including: providing a hole in the ground; inserting an encasement in said hole; providing a growth medium in said encasement; and providing a seed in said growth medium, said encasement adapted to provide a protective environment for said seed to develop.

According to further features the encasement further includes a net structure adapted to hold at least a portion of said growth medium. According to further features the method further includes an external reservoir housing sustenance and an irrigation conduit adapted to convey said sustenance to said encasement.

### BRIEF DESCRIPTION OF THE DRAWINGS

Various embodiments are herein described, by way of example only, with reference to the accompanying drawings, wherein:

FIG. 1 is a simplified overview diagram of an exemplary system for protecting roots of plants in the ground;

FIG. 2 is a diagram of a another exemplary configuration of the instant innovative system;

FIG. 3 is a diagram of an aeroponic growing configuration, according to a preferred embodiment of the invention;

FIGS. 4A and 4B is a diagram of one exemplary arrangement of an irrigation conduit adapted to sustain a predefined level of sustenance;

FIG. 5 is a diagram of a passive hydroponic growing method and system;

FIG. 6 is a diagram of a system which includes a soil based growth medium;

FIG. 7 is a diagram of an exemplary embodiment on the invention wherein the encasement includes a plurality of plants.

### DESCRIPTION OF THE PREFERRED EMBODIMENTS

The irrigation system and method disclosed below is very water efficient and allows a high level of control over the irrigation process while providing nutrients that are usually provided in the form of fertilizer. The irrigation process, together with the controlled environment disclosed below, prevent numerous types of root disease.

Further advantages to the use of such an encasement for the cultivation of plants include: prevention of water and ground pollution caused from chemical seepage into underground water sources; an overall reduction in the amount of chemicals needed per cultivation cycle, since the amount chemicals that are lost to seepage can be lowered to zero or near zero; and the need for chemical pesticides to protect the roots is eliminated in some embodiments and negligible in other embodiments. Containing all the water inside the encasement will keep the area around the plant dry, both on the surface and below the surface, which will decrease the amount of pests in that environment, since most pests are attracted to, and flourish in, moist environments.

Using such a protective encasement will allow the cultivation of plants in any and all types of soil and terrain since the type of earth that the encasement is inserted into, does not affect the contents of the protective encasement. As such, farmers will be able to farm land that is considered unfertile, non-arable, unusable, low-grade, substandard or impractical for farming purposes and has therefore not been used for farming thus far. In some areas there are these types of land are only or primarily available and in other areas these types of land may be substantially cheaper to use. Regular farm land may also be cultivated using the present method and system, in order to enjoy the advantages of the system, some of which are discussed below.

In order to grow a plant in the ground while maintaining a controlled environment for the roots, prior to planting, the roots of the seedling are encased or inserted into a generally non-permeable material, such as a plastic bag or container. In some embodiments the material is biodegradable, and designed to decompose at the end of the plant's lifecycle. This minimizes the affect on the environment and the amount of labor required during each planting cycle. In other embodiments the casing could be made from different materials to create a reusable or disposable (single-use) product.

In some embodiments, the encasement is at least partially permeable, in one direction. For example, a non-permeable polymeric material that includes a section, e.g. a portion of the bottom area, that has a semi-permeable membrane. Exemplarily, waste or excess fluid can drain through the uni-directionally permeable membrane, without any outside material entering into the internal volume of the encasement. The encasement may be flexible (e.g. a planting bag), semi-rigid (e.g. flexible plastic container that is more rigid than a bag but still flexible) or rigid (e.g. a hard plastic similar to container for a potted plant, or some other material). The encasement may be insulated, chemically treated on an internal surface and/or an external surface or any combination thereof. The chemical treatment can include one or more of pesticides, herbicides, weed control agents, pest control agents, ascaricides, molluskicides, insecticides, fungicides, nematocides, etc. An example that would be beneficial is inserting dormant nematodes into the encasement, once the system is planted and water is introduced the nematodes become active and assist with protecting the plant from harmful pests.

The principles and operation of an in-ground root protection system and method according to the present invention may be better understood with reference to the drawings and the accompanying description.

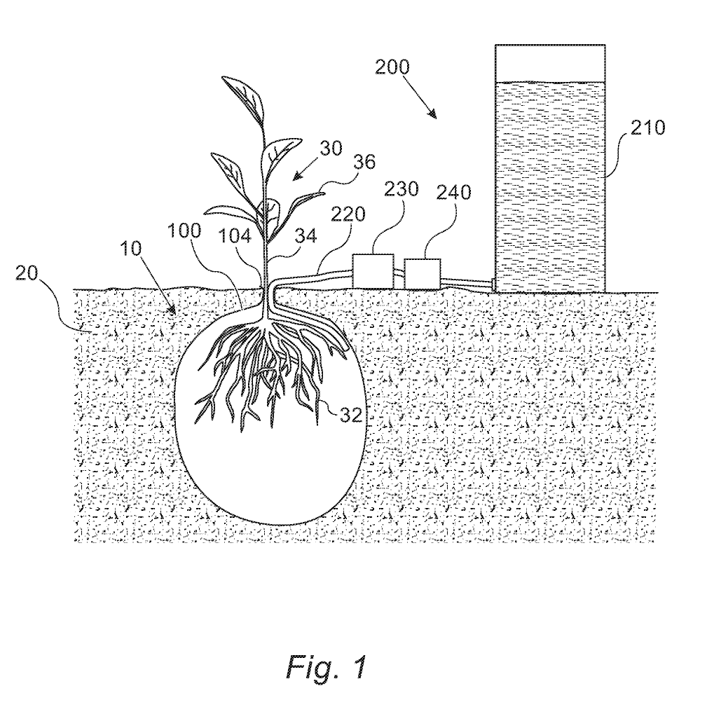

FIG. 1 illustrates a simplified overview diagram of an exemplary system for protecting roots of plants in the ground. The system includes an encasement 100 disposed in a hole 10 formed in soil 20. For example, the soil may be found in a field of non-arable land. The encasement 100 serves as a barrier between contents of encasement and the soil surrounding the hole. The system further includes a feeding means 200, for communicating sustenance to roots of at least one plant 30 disposed in the encasement. The feeding means includes an irrigation conduit 220 operationally coupled to a sustenance reservoir 210 on a proximal end and disposed inside encasement 100 on a distal end, the irrigation conduit adapted to communicate sustenance from the sustenance reservoir to the roots. In some embodiments the feeding means further includes a pump 230. In still other embodiments, the feeding means includes a gas reservoir and/or an air conditioning unit 240.

In embodiments the feeding pipe 220 is adapted to the local climate. For example, feeding pipe 220 may be made from materials of different colors such a color known to dissipate or reflect heat/light which is suited for areas with a warm climate. Alternatively the pipe could be of a color known to better absorb heat, which is more suited for colder areas. Birds are known to be attracted to pipes of certain colors as a source of water, in some embodiments the pipe is made of a color that is not attractive to birds. In some embodiments the pipe could also be made of and/or wrapped in an insulating material to protect the temperature of the water. In another embodiment the pipes could be buried in the ground for insulation and protection from people and animals.

While FIG. 1 depicts a pump, an air conditioning unit, an irrigation conduit (also referred to herein as a feeding tube) and an external reservoir, it is made clear that the system may not include either the pump or the air conditioning unit or both. Furthermore, in some embodiments, the sustenance reservoir is located inside the encasement, either with or without an irrigation conduit. In embodiments which do not include a pump, the sustenance can be distributed to the encasements via other arrangements and methods, e.g., using gravity. In a further example, the system could use existing water pressure (e.g. the reservoir is located in a water tower and gravity builds up water pressure) controlled by a faucet.

With regards to water pressure, in embodiments, water pressure can be generated using a pump or via a gravity arrangement and the like. In both cases water flow and the water level in the encasement are controlled by a faucet, an electric faucet and/or an electric faucet coupled with a pressure switch. As such, the system further includes a water pressure control system operationally coupled to the irrigation conduit, where the control system may be a manually operated faucet, an automatically operated faucet (i.e. with an electronically operated faucet having a solenoid or other electronically operated valve) and/or a manual or automatic (electronic) faucet operationally couple to pressure switch. The pressure switch may be mechanical or electronic.

While the description herein relates to a single encasement and feeding means, it is made clear that the principles of the present invention encompass a plurality of encasements 100 spread over a single geographic location (e.g. a field), A single sustenance reservoir can serve multiple encasements. Each encasement has a dedicated feeding pipe. Each feeding pipe may branch off from a main pipe that connects to the reservoir, or from a subsiduary (or network of subsiduaries) that connects to the main pipe. The system is scalable by installing additional reservoirs (as well as pumps and air conditioning units). Alternatively or additionally, additional pumps may be installed at strategic points to ensure that the sustenance and/or environmental factors (chemical treatments, disinfectants, heated or cooled air etc.) reaches all the encasements, preferrably under uniform pressure. The same applies to air conditioning units and/or gaseous sources. In embodiments, feeding means 200 includes a pressure control arrangement such as a pressure valve (not shown) for controlling the pressure in the irrigation pipe.

The hole is dug in the ground and the encasement, such as a plastic or plant bag, is placed in the hole. The figure depicts a plant bag 100 submerged in a hole 10 in the earth 20. The term “plant bag” is merely exemplary and not intended to be limiting. The plant may be encased or inserted into any relevant type of container that fulfills the definitions and/or descriptions found herein.

Preferably, a plant 30 is inserted in the plant bag 100 with most of the stem part. 34 of the plant protruding from the mouth of the bag, and generally above wound, while the root segment 32 is located entirely in the bag, and generally below the ground level. Some of stem 34 may also be in the bag and/or below ground level. At least one plant 30 is secured in a mouth 102 of the encasement 100, such that roots 32 of the plant descend into an internal volume of the encasement and stem 34 and/or flower 36 of the plant protrude above the soil 20.

In some embodiments, the edges 104 of the opening of the protective encasement jut out of the ground. Plant 30 is secured in the mouth of the encasement by soil which is packed against the stem of the plant, trapping the upper edge 104 of the flexible material against the stem. The earth/soil 20 surrounding opening edges and stem of the plant is packed tight, holding the material edges flush against stem. In this manner the casing is held in place and sealed around the stem.

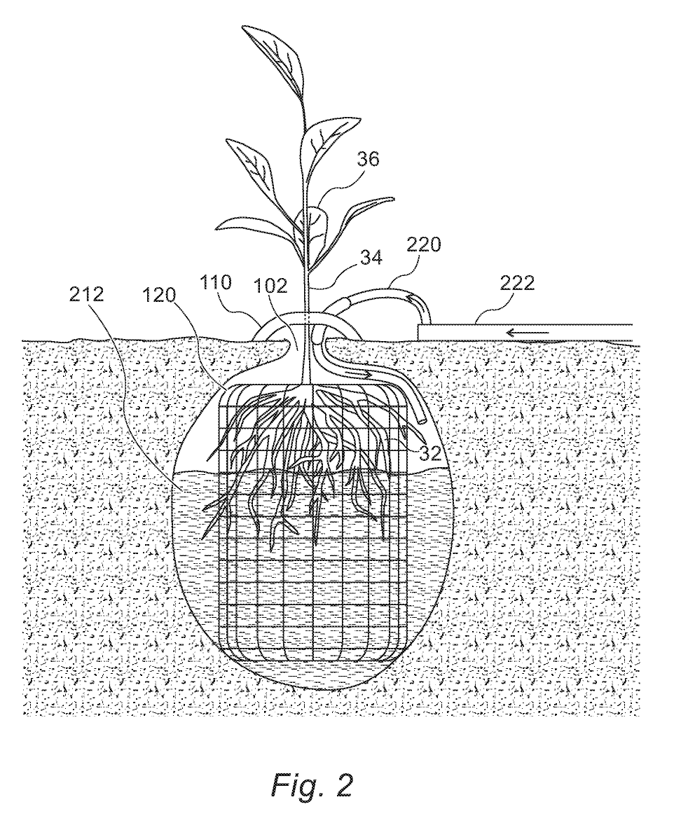

In order to stabilize the plant within the ground and/or prevent the plant or the encasement from collapsing into the ground, one or more additional components may be included in the system to stabilize the plant and/or the encasement and/or the hole and/or the internal volume of the encasement. Some of these exemplary additional components are discussed below with regard to FIG. 2.

The soil 20, hole 10, encasement 100 and plant 30 have been discussed above. The root protection system includes a feeding means 200 for communicating sustenance to growing roots of at least one plant disposed in the encasement. The feeding means 200 is now discussed in further detail. Feeding means 200 includes an irrigation conduit 220 operationally coupled to a sustenance reservoir 210 on a proximal end and disposed inside encasement 100 on a distal end. The irrigation conduit is adapted to communicate sustenance from the sustenance reservoir to the roots 32 inside the encasement. The sustenance reservoir may be a fresh water source, a treated water source, a local reservoir that receives water from a municipal water source and is treated locally with additional nutrients and minerals etc. The sustenance reservoir may alternatively or additionally store a gaseous substance for sustaining and/or treating the roots.

While only a single reservoir is depicted, it is made clear that the term sustenance reservoir includes one or more bodies of fluid, gas and/or nutrients. Sustenance reservoir 210 may further include a filtration system, a plurality of reservoirs, a mixing apparatus (e.g. for mixing nutrients into water, aerating a feed solution etc.), gas containers, a compressor and any other apparatus or machinery necessary to prepare a feed solution.

In some embodiments, feeding means 200 further includes a pump 230 adapted to move sustenance, such as a feed solution, (including health/treatment substances) through irrigation conduit 220 under pressure. In some preferred embodiments, the flow direction in the feeding pipe can be reversed. In some embodiments, the feeding pipe is used for a second purpose, namely to extract material from the bag enclosure, as opposed to inserting material. Exemplarily, some or all of the growing material/growth medium may be extracted from the encasement through the feeding pipe. In embodiments, only small quantities of material are extracted by suction through the feeding pipe, e.g., for sampling purposes. Samples can be tested to ascertain nutrient levels in the growth material and/or general health and wellbeing of the plant environment.

Therefore, in some embodiments the pump 230 is a bi-directional pump which is adapted to selectively either propel the sustenance from the sustenance reservoir to the encasement or suction material out of the encasement. For the health of the plant, it may be necessary to reduce the amount of material that has gathered in the encasement or to completely drain the encasement to prevent root rot and other botanical ailments. The drained material, while not suitable for the plant, may be recycled for other uses.

In some embodiments pump 230 is adapted to communicate gaseous material from a gaseous reservoir/air conditioning unit 240 to the encasement. Exemplarily, the pump can be used to aerate the growing medium (discussed in detail below). In another example, the gaseous substance can be Ozone (O₃) which is used as a disinfectant and antifungal and protects the roots from various maladies. As Ozone also kills some nutrients, it is preferred that Ozone is first inserted into the internal volume of the encasement and only later nutrients are introduced. In some embodiments, the pump can be used to conduct cooled or heated air/gas from air conditioning unit 240, in order to protect the roots from excessive heat or cold which can both be detrimental to the health and wellbeing of the plant. For example, during a heat wave, cooled air can be pumped into the encasement to ensure that the plant can survive the heat wave. Alternatively, when a cold front sets in, the encasement can be heated to ensure that the temperature in the encasement remains within tolerable temperature levels.

FIG. 2 illustrates another exemplary configuration of the instant innovative system. In the depicted configuration, plant 30 is secured in mouth 102 of encasement 100 by a support arrangement 110 resting atop the soil in which the hole is formed. Exemplarily, a clip or fastener or other stabilizing arrangement or apparatus (hereinafter referred to generally as a “stabilizer”) is attached around the stem of the plant, adjacent to the ground. In some embodiments the “stabilizer” is a disc surrounding the stem. Any arrangement or apparatus that secures the edges of the material to the stem and prevents these edges from slipping below the surface is included within the scope of the definition of the stabilizer.

Another feature and function of the stabilizer is to act as an isolating and/or sealing component that keeps the roots of the plant isolated from the surrounding environment. In some embodiments the stabilizer could be made of different colors, surface types and/or textures with different advantageous properties, for example certain colors to attract or reject heat, some colors known to attract or repel insects, etc. In some embodiments the stabilizer contains or is coated with compounds with different properties known in the art, for example rosemary oil known to repel certain insects. In another embodiment the stabilizer is made of an absorbent material which is impregnated with the aforementioned compounds.

In another embodiment the casing is sealed around the stem of the plant with a flexible material having a preferred elastic strength that allows the stem to grow freely and expand as it grows while keeping the encasement sealed. One skilled in the art would be aware of the appropriate elastic material that is sufficiently elastic to secure the material to the stem of the plant while not being too tight to restrict or stunt normal growth of the plant. Alternatively, one of average skill in the art would be capable discovering such a material through trial and error.

In some embodiments, a sponge or sponge-like material is used as a flexible sealant around the stem. The sponge material has the advantage of not burning or searing the plant, even in high temperature areas.

Additionally or alternatively, a structure 120 is disposed inside the encasement 100. In embodiments structure 120 is rigid and adapted to support the encasement against external pressures exerted on the sides and/or from above (e.g. from the weight of the soil above part of the bag, ground movement above surface foot traffic of humans and/or animals, etc.), so as to substantially maintain a constant internal volume which is defined by the encasement and/or the rigid structure 120. Rigid structure 120 preferably fills the entire volume of the encasement. In other embodiments the structure fills only a partial volume of the encasement. The structure may have a net configuration.

In some embodiments, the structure is not rigid but rather semi-rigid or flexible. In some embodiments, the structure is adapted to hold material such as soil and the like. In embodiments, the structure is coated or impregnated with substances that encourage growth of the plant, improve the health of the plant or both. It would be advantageous in some embodiments, to protect the plant roots, especially during the first stages of growth. Preferably, the roots are placed in a protective casing or structure 120 and then placed inside the protective bag/material encasement 100.

In one embodiment, a netting material is used as the protective casing and placed around the roots. The roots together with the netting are placed in the protective encasement/material/bag. In another embodiment, a rigid or semi rigid growing medium can be used as the protective casing.

Encasement 100 is depicted as partially filled with plant sustenance 212. Some of the preferred forms and ingredients of the plant sustenance is described below in further detail. Exemplarily, only a portion of roots 32 are in contact with, or submerged in, the plant feed (sustenance) 212. Exposing a portion of the roots to the naturally oxygen filled environment allows the plant to receive more oxygen (and other components in the air) than the submerged portion. Feeding pipe 220 is adapted to convey sustenance from reservoir 210 (not shown) to the internal volume of the encasement. Sustenance may include fluid, nutrients and/or gas.

Feeding pipe 220 is depicted as branching off a feeder pipe or conduit 222. The feeder pipe may be a main pipe directed connected to the reservoir 210 or a subsiduary pipe that is connected directly or indirectly to a main pipe. Feeding pipe 220 is preferably engaged with support arrangement 110, to better hold the pipe in place.

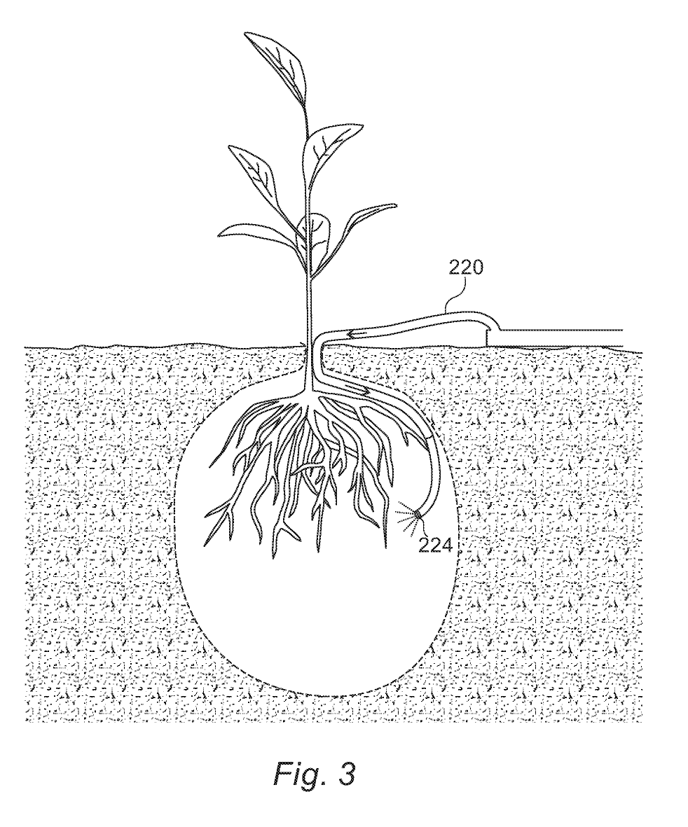

The principles of the present invention encompass variations, combinations and modifications of the illustrated embodiments as well as the described configurations. Elements and components shown in one configuration are understood to be equally applicable to other illustrated and/or described configurations depicted in the figures and described here. Furthermore, not all components depicted in a single figure may be present. For example, the encasement may include the rigid structure 120, but not the support arrangement 110. Alternatively, the rigid structure may be employed in the configuration displayed in FIG. 3. I.e. the components depicted in one figure are not limited to that configuration and are not necessarily employed in the depicted configuration.

In another exemplary embodiment, the structure 120 and/or encasement 100 is filled with one or more of a plurality of substances and materials ranging from liquids alone to materials known in the art, such as different mixtures of soils and/or hydroponic growth mediums. Such materials and configurations allow for the implementation of various hydroponic growing methods, hybrid aeroponic-hydroponic and/or passive hydroponic methods. The versatile nature of the root protective system allows the system to facilitate many different growing techniques.

The plant bag may or may not initially include a growth medium 212 (e.g. including one or more of water, nutrients and gaseous materials). The growth medium inside the bag may be an aquatic medium, soil, an aerobic medium, a gel or a combination thereof.

In some embodiments, soil and plant additives may be added to the growing medium 212 (inside the bag) via the feeding pipe. The additives may include water trapping agents, zeolites, natural enzymes, growth hormones, gibberellins, gibberellic acid, weed control agents, pest control agents, ascaracides, molluskicides, insecticides, fungicides, nematocides or any combination thereof.

In preferred embodiments, a feeding pipe 220 is attached to the encasement or simply inserted therein from the outside. The plant is fed with water, nutrients and/or gaseous materials through the feeding pipe 220. In some embodiments an exemplary gaseous material could include CO₂ (as a source of carbon and oxygen) and O₃ (used as both a source of oxygen for plant roots and a disinfectant). It is to be appreciated that while the encasement is a closed environment, it may or may not be a hermetically sealed and/or sterile environment.

Nutrients may be added to the growing medium (inside the bag) initially and/or through the feeding pipe 212. A plant nutrient can be nitrogen (N), phosphorus (P), potassium (K), calcium (Ca), magnesium (Mg), iron (Fe), zinc (Zn), manganese (Mn), copper (Cu), and boron (B), or any combination thereof; ammonium nitrate, ammonium sulfate, potassium nitrate, potassium thiosulfate, potassium phosphate, potassium sulfate, or any combination thereof.

Protective encasement 100 allows for cultivating plants in several different growing techniques. Exemplarily, structure 120 and/or encasement 100 is left empty of growing medium so as to grow plants in an Aeroponic growing method. FIG. 3 depicts an aeroponic growing configuration, according to a preferred embodiment of the invention. For aeroponic cultivation, the roots are sprayed periodically with a fine mist of fluids and nutrients. To facilitate aeroponic cultivation, irrigation conduit 220 is fitted with a spray nozzle 224 disposed at a distal end thereof. In embodiments, gaseous substances are additionally piped into the encasement through the feeding pipe. In embodiments, pump 230 suctions samples of the environment which are tested in order to regulate the environment (increase/decrease the amount of the sustenance introduced into the encasement and/or the quantities of the various components in the fluid/vapor mixture).

In embodiments, one or more sensors (not shown) are added to the various configurations disclosed herein. Sensors include temperature sensors, humidity sensors, optical sensors, chemical sensors and other sensors known in the art. In embodiments, more than one feeding pipe 220 may be employed in a single encasement to allow circulation of the liquids and gaseous materials throughout the system. For example, one pipe may be for introducing material into the encasement and another for extracting material. One may be inserted into the growth medium and the other may be placed outside of the growth medium.

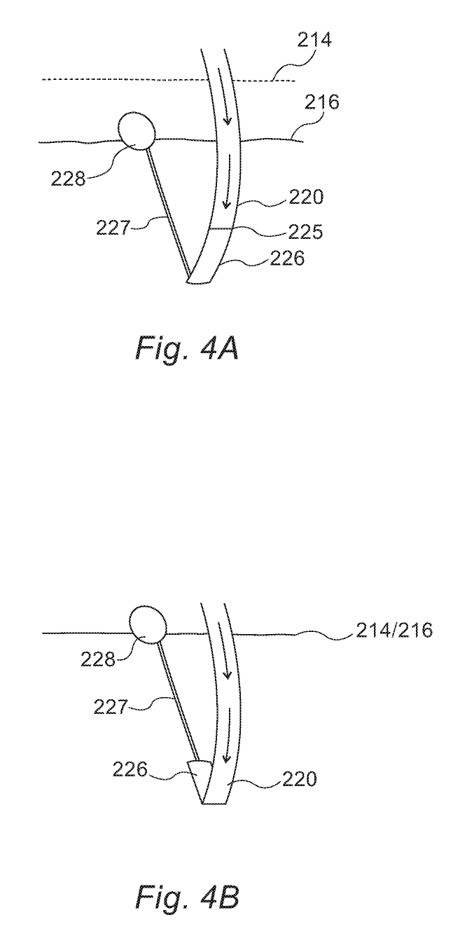

In embodiments which include a fluid growth medium, such as depicted in FIG. 2, the level of the growth medium may be control with various mechanical arrangements. One exemplary arrangement of an irrigation conduit adapted to sustain a predefined level of sustenance is depicted in FIGS. 4A and 4B. FIG. 4A illustrates feeding pipe 220 submerged in a fluid medium 216. Feeding pipe 220 includes an extension segment 226 and a fold line 225. The distal end of pipe 220 is operationally coupled to a flotation device 228, preferably via a stiff connector 227.

The floater device 228 is adapted to allow sustenance through the irrigation conduit 220 into the internal volume when sustenance in the internal volume of the encasement is below a predefined level 214 and to disallow sustenance through the irrigation conduit when the sustenance reaches or is above predefined level 214. When a fluid level 216 is below the predefined level 214, then feeding pipe 220 is held open (or allowed to stay open under pressure of the fluid entering through the pipe). Fluid is introduced into the encasement until the fluid level rises to, or above, predefined level 214. As the water level rises, the floater device also rises, incrementally folding feeding pipe 220 along folding line 225. Once the floater 228 rises high enough, preferably to the predefined level 214, section 226 of feeding pipe 220 folds sufficiently to cut off the flow of fluid from the pipe completely (like folding over the end of a garden hosepipe to stop water from coming out). In such a manner, the level of the fluid in the encasement is controlled and maintained, ensuring that the fluid level is neither too high, nor too low.

In embodiments, a pump, such as pump 230, is operationally coupled to the irrigation conduit 220 and configured to override the floater device 228 if necessary. For example, if the fluid plant feed becomes contaminated or needs to be replaced for some other reason, the fluid pressure in the feeding pipe 220 can be increased to override the function of the floater and open the feeding pipe, even when the fluid level is above the predefined level 214. As such, encasement 100 can be flooded with fluid, thereby effectively rinsing the problematic plant feed sustenance out of the encasement, e.g. via the mouth of the encasement.

In certain areas there is a danger of the water in the feeding tube 220 rising to a high enough temperature that the water will cause damage to the plants. In some embodiments the system includes a heat-sensitive component (not shown) that reacts to high temperature and is adapted, at a given high temperature, to stop the flow of water from entering the feeding tube. For example, many materials expand at high temperatures. One such material (which expands at the temperature that is determined to be detrimental to the plants) can be formed into a valve within the feeding tube. The valve expands at the high temperatures and blocks the feeding tube. thereby preventing the hot water from entering the controlled, enclosed, environment inside encasement 100. Thus the heat-sensitive component acts as a failsafe mechanism to protect against hot water damages.

In some embodiments the system is adapted to grow plants starting from the seed stage. This ability presents a number of advantages, including eliminating the need for a plant nursery. This is especially relevant for isolated farming areas. It would also enable the system to have a long shelf life: ready-to-grow systems including seeds, and in some cases nutrients, could be shipped anywhere in the world.

The current innovation therefore encompasses a method of providing in ground protection, which includes providing a hole in the ground and inserting encasement 100 in the hole. The growth medium is prepared in the encasement and a seed is submerged in the growth medium. The encasement is adapted to provide a protective environment for the seed to develop. In embodiments, the encasement further includes a net structure (e.g. structure 120) which adapted to hold at least a portion of the growth medium. Once the seed starts developing, the stem and plant section gravitates towards to mouth opening 102 of the encasement and the roots extend down further into the growth medium (e.g. plant feed 212, 213). In preferred embodiments the system includes an external reservoir 210 housing sustenance (e.g. fluid, nutrients and/or gas) and an irrigation conduit 220 adapted to convey the sustenance to the encasement in order to supplement the growth medium and provide the preferred environment for the seed suited for different stages of the development of the seed into a fruit producing plant.

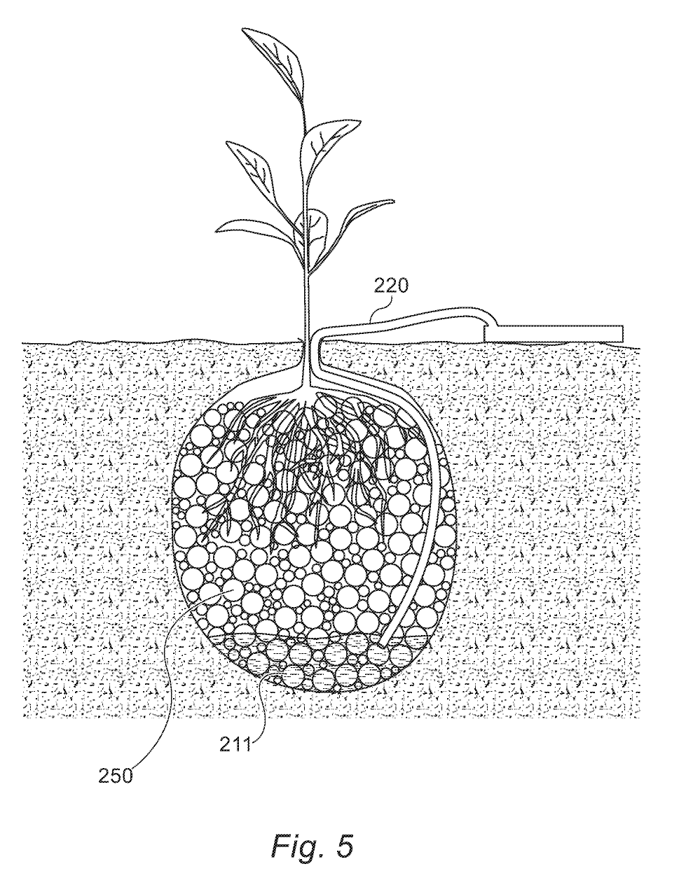

Another possible configuration is shown in FIG. 5 which illustrates a passive hydroponic growing method and system. In the immediate configuration, feeding means 200 includes a sustenance reservoir 211 which is disposed in bottom section of encasement 100. A non-porous material 250 is filled in the encasement, operationally coupling the roots to the sustenance reservoir 211 such that the roots receive sustenance from the sustenance reservoir by capillary action. In some embodiments the internal sustenance reservoir 211 includes sufficient plant feed to sustain the plant through the entire growth cycle. In other embodiments, the system includes an irrigation pipe 220 which replenishes the internal reservoir from an external reservoir 210 and/or provides aeration, necessary nutrients, disinfectants, etc. to the internal reservoir.

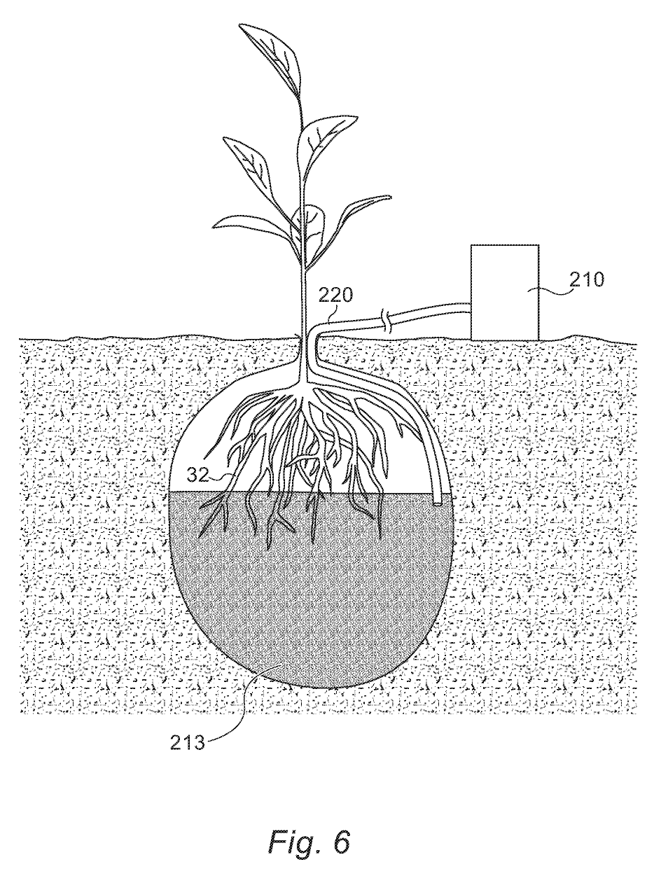

Yet another configuration is shown in FIG. 6, which depicts a system which includes a soil based growth medium 213. In the exemplary embodiment, roots 32 are partially submerged in growth medium 213. In other embodiments, the roots are substantially entirely submerged in the growth medium. In other embodiments, as discussed above, the growth medium may be in a net structure (e.g. structure 120). Irrigation/feeding pipe 220 is submerged in the soil based growth medium. As such, fluid and nutrients can be delivered into the soil (or other non-fluid) medium from reservoir 210. Furthermore, oxygen and/or other gaseous substances can be introduced into the growth medium, as aerating the growth medium is vital to the survival of the plant. As discussed above, reservoir 210 may include a first reservoir for fluids and nutrients and a second reservoir for gases (or any other arrangement as relevant).

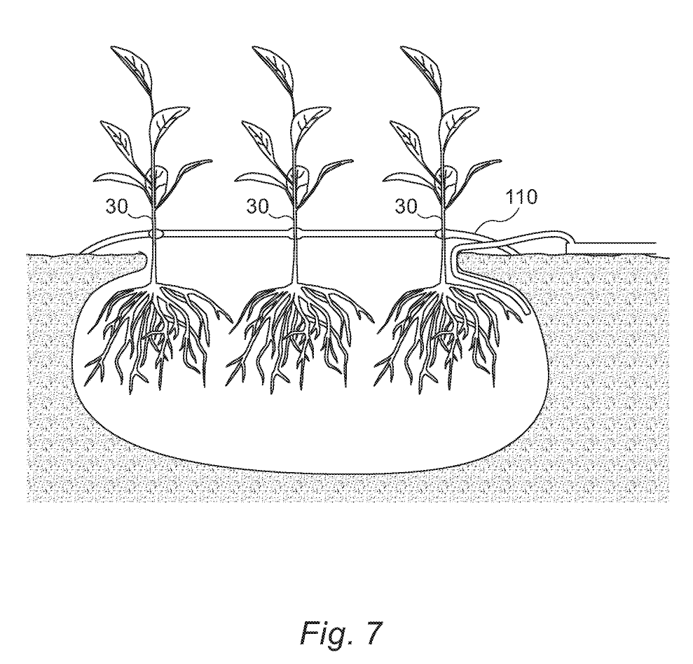

Yet another configuration is depicted in FIG. 7, which illustrates an exemplary embodiment on the invention wherein encasement 100 includes a plurality of plants 30. In one embodiment, the plurality of plants are supported, and spaced apart, by a support arrangement resting atop the ground in which the hole is formed.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A system for protecting roots of plants, comprising:
an encasement disposed in a hole formed in soil, said encasement serves as a barrier between contents of said encasement and said soil surrounding said hole; and
a feeding means, for communicating sustenance via a mouth of said encasement to roots of at least one plant disposed in said encasement.

2. The system of claim 1, wherein said at least one plant is secured in said mouth of said encasement, such that roots of said at least one plant descend into said encasement and a stem and flower of said at least one plant protrude above said soil.

3. The system of claim 2, wherein said encasement is a formed of a flexible material.

4. The system of claim 3, wherein said at least one plant is secured in said mouth of said encasement by said soil packed against said stem, trapping an upper edge of said flexible material against said stein.

5. The system of claim 2, wherein said at least one plant is secured in said mouth of said encasement by a support arrangement resting atop said soil in which said hole is formed.

6. The system of claim 2, wherein at least part of said encasement has at least one characteristic selected from the group including: biodegradable, semi permeable, non permeable, flexible, semi-rigid, rigid, insulated, chemically treated on an internal surface, an external surface with one or more substances selected from the group including: pesticides, herbicides, weed control agents, pest control agents, ascaricides, molluskicides, insecticides, fungicides, nematocides.

7. The system of claim 1, further comprising a rigid structure disposed inside said encasement, said rigid structure adapted to support said encasement, which defined an internal volume therein, against external pressure.

8. The system of claim 1, wherein said feeding means includes an irrigation conduit operationally coupled to a sustenance reservoir on a proximal end and disposed inside said encasement on a distal end, said irrigation conduit adapted to communicate sustenance from said sustenance reservoir to said roots.

9. The system of claim 8, wherein said sustenance reservoir includes at least one of: fluid, gas and nutrients.

10. The system of claim 9, further comprising a pump adapted to move sustenance through said irrigation conduit under pressure.

11. The system of claim 10, wherein said pump is adapted to selectively propel said sustenance from said sustenance reservoir to said encasement and suction material out of said encasement.

12. The system of claim 10, wherein said pump is adapted to communicate gaseous material from a gaseous reservoir to said encasement.

13. The system of claim 12, wherein said gaseous material is heated or cooled.

14. The system of claim 1, wherein an internal volume of said encasement is partially filled with sustenance such that only a portion of said roots are in contact with said sustenance.

15. The system of claim 14, further comprising an irrigation conduit adapted to sustain a predefined level of said sustenance.

16. The system of claim 15, further comprising a floater device adapted to allow sustenance through said irrigation conduit into said internal volume when said sustenance in said internal volume is below said predefined level and to disallow sustenance through said irrigation conduit when said sustenance is above said predefined level.

17. The system of claim 16, wherein said sustenance is conveyed though said irrigation conduit at a pressure configured to override said floater device.

18. The system of claim 8, wherein said irrigation conduit has a spray nozzle disposed at a distal end thereof.

19. The system of claim 1, wherein said feeding means includes:
an internal sustenance reservoir disposed inside said encasement, and
a non-porous material operationally coupling said roots to said internal sustenance reservoir such that said roots receive sustenance from said internal sustenance reservoir by capillary action.

20. The system of claim 19, further comprising an irrigation conduit operationally coupled to an external reservoir on a proximal end and disposed inside said encasement at a distal end, said irrigation conduit adapted to communicate sustenance from said external reservoir to said internal sustenance reservoir disposed in said encasement.

21. The system of claim 1, wherein said encasement includes a plurality of plants.

22. The system of claim 21, wherein said plurality of plants is secured in a mouth of said encasement by a support arrangement.

23. A method of providing in ground root protection, comprising:
providing a hole in the ground; inserting an encasement in said hole; inserting a plant in said encasement such that roots of said plant are disposed inside said encasement and at least part of a stem of said plant protrudes out of said encasement via a mouth of said encasement;
providing sustenance to said roots disposed in said encasement via said mouth.

24. The method of claim 23, wherein said sustenance is housed in an external reservoir and conveyed to said roots via an irrigation conduit.

25. The method of claim 23, wherein said sustenance is disposed inside said encasement.

26. The method of claim 25, wherein said encasement further comprises non-porous filling and said sustenance is conveyed to said roots via capillary action.

27. The method of claim 24, wherein said sustenance is conveyed in a vapor form.

28. The method of claim 24, wherein material disposed in said encasement is extracted via said irrigation conduit.

29. The method of claim 23, wherein said plant is held in said encasement by a support arrangement.

30. The method of claim 29, wherein said support arrangement secures a flexible edge of said encasement against said stem.

31. A method of providing in ground protection, comprising:
providing a hole in the ground;
inserting an encasement in said hole;
providing a growth medium in said encasement; and
providing a seed in said growth medium, said encasement adapted to provide a protective environment for said seed to develop.

32. The method of claim 31, wherein said encasement further includes a net structure adapted to hold at least a portion of said growth medium.

33. The method of claim 31, further comprising an external reservoir housing sustenance and an irrigation conduit adapted to convey said sustenance to said encasement.
